(19) United States
(12) Patent Application Publication
(10) Pub. No.: US 2026/0004121 A1
(43) Pub. Date: Jan. 1, 2026

(54) ITERATIVE DATA PROCESSING OPTIMIZATION ENGINE IN A DATA INTELLIGENCE SYSTEM

(71) Applicant: Microsoft Technology Licensing, LLC, Redmond, WA (US)

(72) Inventors: Daniel Lee MACE, Bellevue, WA (US); Max Piasevoli, New York, NY (US); Melissa Ailem, Los Angeles, CA (US); Srisuma Movva, Seattle, WA (US); Wesley Hsien-Yi Chan, Sammamish, WA (US); William Blum, Bellevue, WA (US)

(21) Appl. No.: 18/759,845

(22) Filed: Jun. 29, 2024

(51) Int. Cl. G06N 3/08

(52) U.S. Cl. CPC G06N 3/08

(57) ABSTRACT

Methods, systems, and computer storage media for providing iterative data processing optimization using an iterative data processing optimization engine in a data intelligence system are described. Iterative data processing refers to handling data where the processing steps are repeated multiple times, across multiple views or modalities, to train machine learning models, filter and score data or generate output. The iterative data processing optimization engine employs expectation step machine learning models that are simple but with fast language models to efficiently and effectively probe and analyze data, while iteratively refining maximization step machine learning models that are optimized and fast to approximate the probing mechanism of the expectation step machine learning models more efficiently, for example, using metadata, external information, and compressed representation. The iterative data processing optimization engine can operate based on an agentic framework using lightweight artificial intelligence (AI) agents to perform model fitting, featurization, and report generation autonomously.

### BACKGROUND

Users rely on computing systems to analyze vast amounts of data, derive insights, and make informed decisions. A data intelligence system refers to sophisticated platform design to collect, process, analyze, and present data to help user make informed decisions. In particular, the data intelligence system may integrate various data sources, employ advanced analytics, and provide actionable insights through intuitive visualizations and report tools. For example, a data intelligence system can support visualizing trends, patterns, and anomalies. The data intelligence can enable real-time monitoring, predictive analytics and comprehensive reporting, enhancing strategic planning and operational efficient for across a wide range of domains from cybersecurity to healthcare.

### SUMMARY

Various aspects of the technology described herein are generally directed to systems, methods, and computer storage media for, among other things, providing iterative data processing optimization using an iterative data processing optimization engine in a data intelligence system. Iterative data processing refers to handling data where the processing steps are repeated multiple times, across multiple views or modalities, to train machine learning models, filter and score data or generate output. The iterative data processing optimization engine employs expectation step machine learning models that are simple but with fast language models (e.g., foundation models, large language models (LLMs), small language models (SLMs), mixture of expert models (MoE), or multi-modal model) to efficiently probe and analyze data (e.g., probing mechanism on a small sample of a dataset). The probing mechanism enables efficiently extrapolating the probe analysis evaluation to the complete dataset.

The iterative data processing optimization engine also iteratively refines maximization step machine learning models that are optimized and fast to approximate the probing mechanism of the expectation step machine learning models more efficiently; for example, using metadata, external information and/or compressed representations (e.g., embeddings). The iterative data processing optimization engine can operate based on an agentic framework using lightweight artificial intelligence (AI) agents to perform different types. For example, AI agents can be used to modify a step of probe questions based on sample outputs including modifying the wording of probe questions, adding new probe questions, and so on; and AI agents can support model fitting, featurization, and report generation autonomously. In this way, iterative data processing optimization engine enables processing large datasets to identify action insights via an automated data processing pipeline that ensures efficient and precise analysis.

Conventionally, data intelligence systems are not configured with comprehensive logic, infrastructure and data convergence functionality to efficiently and adequately provide iterative data processing. Data intelligence systems operate based on vast amounts of datasets that include human-readable content that is both structured and semi-structured, making it too large for a machine learning models (e.g., large language models (LLM) to process the datasets in their entirety). It is necessary to identify and filter the relevant data before processing. Moreover, without effective data convergence functionality, current data intelligence systems are unable to harmonize disparate data sources or streams into a consistent and reconciled state for processing, which often results in discrepancies, errors, or incomplete information, hindering the data intelligence system's ability to provide accurate and reliable outputs. In addition processing large datasets without iterative processing functionality, especially with LLMs or other machine learning models, leads to several limitations: reduced accuracy, inability to handle complexity, data quality issues, scalability problems, inflexibility to new data, increased risk of overfitting or underfitting, limited error correction, and poor optimization. These issues collectively hinder the effectiveness, accuracy, and scalability of data analysis. Processing large datasets in one go can be computationally exhaustive and not technically feasible. Iterative approaches can break the task into manageable chunks, making it more scalable and efficient.

A technical solution—to the limitations of conventional data intelligence systems—can include providing iterative data processing optimization resources via an iterative data processing optimization engine that employs an iterative approach for learning, filtering, and scoring data (e.g., email, documents) to identify individual data items (e.g., an email, a document from a large corpus) of interest for a particular topic. The iterative approach can be an Expectation Maximization approach (e.g., an iterative optimization loop) for LLMs that enable recursive improvement in filtering and ranking data. The iterative optimization loop begins with a set of probe questions and iterates through steps of the iterative optimization loop. An expectation step, where a probe prompt (e.g., simple yes/no) is designed and executed against the data using an expectation step machine learning model (e.g., an LLM) that is used to generate M×N matrix evaluations, indicating a relevance of each data item in the data with respect to the set of probe questions. For example, the expectation step machine learning model is employed to optimize a latent variable (i.e., an observed expectation output) in data items. At a maximization step, the latent variable can be used to train a maximization step model (e.g., a lightweight model). The lightweight model is faster and configured to use a more accessible view of data (e.g., metadata, external information). In particular, the observed expectation output from the LLM probes is fitted using a lightweight predictive model-such as a Light Gradient Boosting Machine “LightGBM” or Extreme Gradient “XGBoost”. This model uses tokenized metadata to score and rank data items, streamlining the process of pertinent data.

In particular, the observed expectation output from the LLM probes is fitted using a lightweight predictive model-such as a Light Gradient Boosting Machine “LightGBM” or Extreme Gradient “XGBoost”. This model can use different types of input features to score and rank data items, streamlining the process of pertinent data. Input features (e.g., tokenized text, embeddings, metadata, attachment details) can be selected to align with specific task goals, data characteristics, and computational constraints. The flexibility in feature selection allows tailoring the model to extract meaningful insights and make accurate predictions based on the available information in the corresponding dataset.

At a prediction and resample step, the trained maximization step model is then applied to the dataset, with the results ranked. A new weighted sample of the dataset is selected (e.g., from the latest ranked dataset) for further analysis. The iterative optimization loop is repeated, enhancing the maximization step model's ability to identify data items relevant to a particular topic. Upon running the trained maximization step model on the data, downstream analysis (e.g., deep analysis inspection) can be performed using LLMs. Downstream prompts can be used to extract detailed information from data items. For example, for email data items, in a cybersecurity context, vulnerability descriptions, risk levels, and potential attack vectors can be identified. The iterative data processing optimization engine enables intelligent scaling to accommodate the size of the data corpus. The iterative data processing optimization engine can perform computations using Graphics Processing Units (GPUs) instead of Central Processing Units (CPUs) to support faster training. Moreover, the iterative data processing optimization engine be implemented based on an agentic framework that employs LLM agents to perform different steps of the iterative data processing optimization engine.

In operation, in a first embodiment, a first set of probe questions associated with a data instance is accessed. The data instance comprises data items and the data instance is a subset of a dataset. Using expectation step model, the set of probe questions, and the data instance, an observed expectation output comprising responses to the set of probe questions associated with the data items in the data instance is generated. The expectation step model is a large language model that generates the responses in the observed expectation output using the set of probe questions and the data instance. Training data input associated with the data instance is accessed. A maximization step model is trained on the observed expectation output and training input data associated with the data items. Using the maximization step model, a predicted output—for the data items in the dataset—is generated for the data items in the dataset. A subset of data items of the predicted output is identified for a second iteration of iteratively training the maximization step model. The second iteration of iteratively training the maximization step model is triggered based on the subset of data items of the predicted output. Iteratively training the maximization step model comprises iteratively refining parameters in the maximization step model based on iterations of observed expectation outputs associated with iterations of data instances of the dataset.

In a second embodiment, a dataset comprising data items is accessed at an iteratively trained machine learning model. The iteratively trained machine learning model is trained based on two or more iterations of observed expectation outputs associated with a set of probe questions associated with a topic. Predicted output comprising a plurality data items in the dataset is generated using the using the iteratively trained machine learning model. A subset of the plurality of data items is selected based on corresponding ranks of the plurality data items. A downstream output is generated based on executing one or more downstream prompts on the predicted output. The downstream output is ranked. The downstream output is communicated to cause display of the downstream output.

In a third embodiment, a set of probe questions associated with a data instance comprising data items are accessed. The data instance is a subset of a dataset. An observed expectation output—for the set of probe questions and the data items in the data instance—is generated. The expectation step model is a large language model (LLM) that generates responses to the set of probe questions for the observed expectation output. A maximization step model is trained on the observed expectation output and the training input data associated with the data items. A predicted output for data items in the data instance is generated using the maximization step model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A-1C are block diagrams of an exemplary data intelligence system including an iterative data processing optimization engine, in accordance with aspects of the technology described herein;

FIGS. 2A-2B are block diagrams associated with an exemplary data intelligence system including an iterative data processing optimization engine, in accordance with aspects of the technology described herein;

FIG. 3 provides a first exemplary method of providing iterative data processing optimization using an iterative data processing optimization engine, in accordance with aspects of the technology described herein;

FIG. 4 provides a second exemplary method of providing iterative data processing optimization using an iterative data processing optimization engine, in accordance with aspects of the technology described herein;

FIG. 5 provides a third exemplary method of providing iterative data processing optimization using an iterative data processing optimization engine, in accordance with aspects of the technology described herein;

FIG. 6 provides a block diagram of an exemplary data intelligence system suitable for use in implementing aspects of the technology described herein; and

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

A data intelligence system provides a platform or framework designed to collect, process, analyze, and interpret large volumes of data from various sources to derive actionable insights and support decision-making processes. Data intelligence systems often utilize advanced technologies such as artificial intelligence, machine learning, natural language processing, and data visualization techniques to uncover patterns, trends, correlations, and anomalies within the data.

By way of illustration, in cybersecurity, a data intelligence system supports proactive monitoring, data protection measures, incident response protocols, and regulatory compliance strategies to safeguard digital assets from threats and breaches. In particular, the data intelligence system integrates proactive and retroactive measures to handle data breaches, data protection, and governance effectively. Proactive measures involve continuous monitoring to detect anomalies and alert teams in real-time. Vulnerability assessments and penetration testing identify and patch security weaknesses preemptively. The data intelligence system monitors and analyzes network traffic, system logs, and other data sources to detect and respond to security threats. It uses advanced algorithms to identify suspicious activities, such as unauthorized access attempts or malware infections, and provides real-time alerts to security teams. By correlating data from multiple sources, it can uncover complex attack patterns and help organizations strengthen their defenses. Data protection strategies include encryption for data at rest and in transit, ensuring unauthorized access results in unreadable data without decryption keys. Access controls enforce least privilege principles to limit access to sensitive data.

In retroactive scenarios, incident response protocols outline steps to swiftly contain, mitigate, and recover from breaches. Rapid response teams execute plans while preserving evidence for forensic analysis. Data governance establishes policies for regulatory compliance with audits ensuring secure data storage and backup practices. User awareness programs educate employees on cybersecurity best practices, reducing human error risks. Continuous improvement uses threat intelligence for adaptive security updates and response strategies against emerging threats. Tabletop exercises prepare teams to handle evolving cyber threats effectively.

In legal discovery context, a data intelligence system sifts through vast amounts of electronic files, documents, emails, and other digital records-sometimes stored in file systems, databases, or cloud storage—to find relevant information for legal proceedings. It employs machine learning and natural language processing techniques to identify key documents, extract important facts and relationships, and categorize information according to legal, compliance, and security risk requirements. This helps legal teams streamline the discovery process, reduce costs, and ensure compliance with legal obligations. As such, data intelligence systems enable informed decision-making, provides a competitive edge, manages risks, enhances efficiency, improves customer experiences, reduces costs, ensures regulatory compliance, fosters innovation, and drives growth.

Conventionally, data intelligence systems are not configured with comprehensive logic and infrastructure to efficiently and adequately provide iterative data processing. Iterative data processing can specifically include multi-view iterative processing where data is examined through multiple perspectives or “views,” each offering different levels of detail and corresponding computational costs. The process starts with less detailed views (lower levels) to gain initial insights and identify relevant data. Based on these preliminary results, the analysis iteratively refines and focuses on more detailed views (higher levels) as needed. This method enables effective use of each level with minimal costs and expense on lower levels.

Without iterative multi-view processing, a data intelligence system faces several limitations. It can lead to inefficient resource utilization and high computational costs. This approach causes scalability issues, reduces system responsiveness, and risks overloading computational resources. Additionally, the data intelligence system lacks flexibility to adapt processing strategies based on intermediate results, which can result in missed insights and poor cost management. By implementing iterative multi-view processing, these challenges can be mitigated, leading to a more strategic and efficient data analysis process. In this way, iterative multi-view processing provides an analytical approach where data is examined through multiple views each offering different levels of detail and computational costs.

Moreover, processing large datasets without iterative processing functionality, especially with LLMs or other machine learning models, leads to several limitations, particularly regarding scaling and throughput limitations. LLMs are computationally expensive models that require significant computational resources and time to run effectively. When dealing with a vast amount of data, such as in the case of a data breach corpus, these challenges become more pronounced. LLMs demand substantial computational resources, including high-performance CPUs or GPUs, to process large datasets efficiently. However, even with powerful hardware, processing a massive corpus of data can be time-consuming and resource-intensive. Scaling LLM-based methods to handle large datasets effectively is challenging. As the size of the corpus increases, so does the computational complexity and memory requirements. Scaling to process terabytes or petabytes of data becomes increasingly difficult due to hardware limitations and software optimizations. Moreover, throughput, or the rate at which data can be processed, becomes a bottleneck when dealing with large datasets. LLMs often have limited throughput capabilities, meaning they can only process a certain amount of data within a given timeframe. This limitation becomes more pronounced when iterating and improving prompts on the data breach corpus, as each iteration requires processing the entire dataset. As such, a more comprehensive data intelligence system—with an alternative basis for performing data intelligence operations across multiple granularities of views with disparate cost margins—can improve computing operations and interfaces in data intelligence systems.

### Description of Technical Solution

At a high level, the iterative data processing optimization engine provides iterative scoring and adaptation pipeline for optimized data analysis. In particular, iterative data processing optimization engine provides iterative data processing optimization engine operations that are performed across multiple granularities of views with disparate cost margins to provide strategic analysis of data across various levels of detail while considering different cost implications. The iterative data processing optimization engine supports collecting, processing, analyzing, and interpreting data to extract meaningful insights and intelligence—at different levels of detail or abstraction—and at varying levels of computational costs associated with aspects of iterative data processing.

The iterative data processing optimization involves two phases: the expectation step and the maximization step. In this context, the expectation step represents an initial phase associated with an expectation step model (e.g., a language model), where the model assesses data from a specific perspective or modality of the dataset. This phase is characterized by a computational cost associated with processing data at a foundational level. Subsequently, the maximization step follows as a secondary phase resembling associated with a maximization model (e.g., a lightweight predictive model), where the model further refines its understanding by considering data from an alternative viewpoint or modality. This phase entails its own computational cost, reflecting the resources required to analyze data at a more detailed or specialized level. Together, these iterative steps enable the model to iteratively enhance its learning and optimization processes, leveraging diverse data perspectives to generate analytical output.

The iterative data processing optimization engine provides a scoring mechanism (e.g., a risk score or relevance score) and filtering pipeline that adapts and adjusts to new information as data is processed through the pipeline. In this way, the score filtering and prioritization are continuously and iteratively learning from previous results. This iterative approach improves and focuses prioritization and analysis of the data. For example, in a cybersecurity context, emails with the highest risks scores indicating vulnerabilities or other threats are efficiently identified and analyzed. The iterative data processing optimization engine operates based on a Language-Model-based Expectation Maximization (EM) algorithm that allows the recursive updates to filtering and ranking algorithm. The recursive update can be configured to be implemented semi-automatically.

By way of illustration, a set of probe questions are provided. Probe questions, within the context of a probing mechanism, are inquiries designed to elicit specific information or insights from a dataset. A probe question refers to a specific query or inquiry designed to extract targeted information or insights from a dataset. These probe questions are formulated based on the content and structure of the data items within the dataset. Probe questions typically aim to uncover patterns, relationships, anomalies, or trends in the data. They serve as focused prompts that guide the exploration and analysis of data to achieve specific objectives or to answer particular research questions. An expectation step model receives the set of probe questions and generates answers for the problem questions based on the content a data item of a dataset (e.g., email data items of email corpus). The probe questions can be associated with a specific topic or a specific type of information that is relevant to the topic in the dataset.

The set of probe questions can be curated manually or automatically. For example, a language model can adjust a set of probe questions. This adjustment involves modifying the wording of existing questions to better fit the nuances of the data or adding entirely new questions based on the responses it generates from sample outputs. This capability allows refining an understanding and exploration of the dataset, potentially uncovering deeper insights or refining its analysis based on the evolving context or requirements of the task at hand.

Probe questions can be in different type of question formats (e.g., simple yes/no questions, open-ended questions) that an expectation step model will answer based on the content of data items in a dataset. For example, for email data items in an email data, probe questions for cybersecurity enforcement can include: “Does this email discuss a vulnerability related to a storage data?” or “Does this email discuss an (multi-factor authentication) MFA bypass or similar identity vulnerability?” Both probes check for risky email content but in different forms. In this way, the probe questions can be in different forms but check for the same category of information.

A data instance (e.g., a small sample of a dataset) can be processed through probe evaluation. The data items of the data instance may be a curated data items (e.g., automatically and/or manually). For example, emails may be curated using a combination of keyword-based identification (e.g., keyword-based identifiers) of emails and manually selected clusters derived from machine learning techniques (e.g., machine learning clustering) on email subjects. The first data instance forms a starting point for analysis using the iterative data processing optimization engine.

A probing wrapper prompt (e.g., yes/no wrapper prompt) is queued up to be executed on the data items of the data instance (e.g., a first data instance) using an expectation step model (e.g., foundation models, large language models (LLMs), small language models (SLMs), mixture of expert models (MoE), or multi-modal model). The expectation step model generates an observed expectation output associated with the data instance. The observed expectation output includes responses to the set of probe questions associated with the data items in the data instance. The observed expectation output can be formatted in M×N matrix of evaluations, where M is a number of initial filtered data items of the data instance, and N is a number of probe questions. The observed expectation output is an indicator matrix of 0/1 values for each probe.

Training input data associated with the data instance is accessed for training the maximization step model. The training data input can be associated with features from feature engineering that encompasses various techniques and processes involved in transforming raw data (i.e., data instance) into a format that is more suitable for training machine learning models. Feature engineering involves selecting, transforming, and creating features (including embeddings or metadata) from the raw data to improve the performance of the model during training. For example, the training data input can be tokenized representations of the metadata of the data item, such as email metadata that can include subject line, the recipients, the sender, the attachments, as well as other metadata information (e.g., organization hierarchy of sender, sender membership of privileged security groups, attachment size, etc.) The maximization step model can be flexible to accommodate a variety of different input data types.

The maximization step model is trained during the maximization step and the trained maximization step model is employed to process the dataset. The maximization step model (e.g., a LightGBM/XGBoost) is trained (e.g., fitted) on the observed expectation output. Fitting refers to the process of training the maximization step model using training input data and observed expectation output at target outputs. The goal is for the model to learn patterns and relationships within the data, adjusting its internal parameters (such as weights in neural networks or coefficients in linear regression) to minimize the difference between predicted outputs and actual outputs. Fitting involves finding the optimal configuration of the model to accurately represent the underlying relationships in the training data, thereby enabling it to make reliable predictions on new, unseen data. Fitting in the context of a single regression output involves finding the best-fitting line (or curve) that represents the relationship between an independent variable (input) and a dependent variable (output). This process aims to minimize the difference between the predicted values from the regression model and the actual observed values of the dependent variable. Through fitting, the regression model determines the optimal coefficients (slope and intercept) that define this line or curve, ensuring it closely matches the data points and accurately captures the trend or pattern in the data.

When training the maximization step model, an augmented scoring mechanism is employed to provide a single regression output (i.e., a sum of all the columns). A single regression output typically represents the predicted numerical value of a dependent variable based on the input of one or more independent variables, aiming to quantify the relationship between them. In the alternative, a multivariate output (75 dimensions 0/1 outcomes); or a multivariate output formulation that sums probe responses into subcategories of scores can be employed. For example, for risk scores of emails, responses can be in subcategories of vulnerability risks scores, where storage specific vulnerability risk scores and identity authorization risk scores are defined for more focused ordering and downstream analysis of emails. The single regression output may ultimately be employed for simplicity and performance gain associated with the maximization step model. In this way, fitting can be done iteratively with different iterations of observed expectation outputs and training input data. Each iteration refines the maximization step model's parameters to better capture the underlying patterns and relationships in the data specific to the iteration of the data instance and observed expectation outputs. This iterative process allows the maximization step model to generalize more effectively across different instances of the training data, improving its ability to make accurate predictions or classifications on unseen data.

The maximization step model generates a predicted output based on the dataset (e.g., remaining emails in an email corpus). A predicted output refers to data items that have been identified as most pertinent to a topic based on the trained maximization step model's analysis. The predicted output represents the trained maximization step model's estimation of which data items are most likely to contribute valuable information or insights regarding the specified topic. For example, the trained model from the maximization step is then executed on top of the remaining emails to identify risky emails (i.e., predicted output). The data items can be scored and ranked (e.g., descending order).

In addition to the data instance (i.e., first data instance of filtered data items) passed through the probes, the iterative data processing optimization engine can provide and process a second data instance of negative data item samples (i.e., a negative sample data instance). The negative sample data instance may refer to data items that do not contain the relevant information associated with a topic. The data items are automatically assigned a regression output of 0. For example, a negative sample of emails includes emails that will not contain risky content, the negative sample of emails are automatically assigned a regression output of 0. The data items in the negative sample data instance may be identified through manual inspection and their inclusion allows the iterative optimization loop to remove focus from noisy and frequent data items.

A new weighted sample (i.e., a subsequent data instance) of data items can be identified from the dataset. A weighted sample refers to a subset of data items where each data item is given a weight to reflect its relative importance or representation within the entire dataset. The new weighted sample is taken from the dataset for a second iteration of probe prompt analysis. The new weighted sample can specifically take from the latest scored dataset (e.g., latest scored email corpus).

The sample of data items can be conducted in a way that the iterative optimization loop process can further refine how to determine or score (e.g., a first relevance framework) relevant data items (e.g., riskiest emails) while allowing discovery of different types of relevant data items (e.g., via a second relevance framework) with properties that are distinct from the first relevance framework. For example, the sampling of emails can be conducted to refine a current perception of the riskiest emails while allowing it to discover new pockets of risky emails with properties that are distinct from its current perception of risk.

As part of the iterative processing, it is contemplated that the set of probe questions can be can refined (i.e., an updated set of probe questions) based on the latest responses. In addition, or alternatively, new data items can be added to the negative sample data instance prior to another iterative optimization loop iteration. With a subsequent data instance of data items, the iterative data processing optimization engine can re-run the iterative optimization loop thereby improving visibility to data items that are important to a topic of interest. For example, identifying emails that are relevant from a vulnerability and risk perspective.

To determine the number of iterations for the optimization loop, two approaches can be used. A qualitative approach involves manual inspection, where the loop continues until the latest rankings appear reasonable to the investigator, based on domain knowledge and expert judgment. The quantitative approach employs a convergence metric, such as the change in loss function value or differences in predicted outputs/rankings between successive iterations. When this metric falls below a predetermined threshold, indicating minimal improvement, it can be assumed that the optimization loop has reached a stable state, and further iterations are unlikely to yield significant benefits. This ensures both subjective validation and objective convergence criteria are met for the iterative optimization process.

The iterative data processing optimization engine predicted output can further be analyzed with a downstream analysis tool. The downstream analysis tool can include one or more LLMs that perform additional analysis data items in datasets. For example, in a cybersecurity context, downstream analysis tool can provide downstream vulnerability analysis. Downstream analysis can be performed to evaluate vulnerability of emails. The downstream analysis tool of the iterative data processing optimization engine can be explained by way of example illustration. In particular, while the ranking models (i.e., expectation step model and maximization step model) are iteratively improving their models, a set of downstream prompts can be employed to extract and gather in depth analysis of emails.

A relevance prompt can be performed on the predicted output to identify a structured set of relevant information. For example, a relevance prompt can be a vulnerability prompt designed to extract a structured set of vulnerability information from the emails. A structured set of vulnerability information in an email includes categorized details about identified vulnerabilities providing recipients with actionable insights to address security risks effectively. Structured vulnerability information can include descriptions, risk levels, reproducibility risks/descriptions, identifiers (e.g., security bugs, case numbers), affected products/services, involved security team, and relevant search information.

A framework-based analysis can also be performed on the predicted output. A framework-based analysis can be associated with a structured cybersecurity framework (e.g., MITRE ATT&CK—Adversarial Tactics, Techniques, and Common Knowledge). The structured cybersecurity framework is used understand and categorize the tactics and techniques employed by adversaries during cyberattacks. It serves as a reference guide for cybersecurity professionals, providing a common language and structure for discussing and analyzing cyber threats. This framework typically organizes adversary behavior into categories based on different stages of an attack, such as initial access, execution, persistence, and exfiltration. Each category includes various techniques used by adversaries, along with descriptions, examples, and potential mitigations. By utilizing this framework, organizations can enhance their understanding of cyber threats, develop more effective defensive strategies, and improve incident response capabilities.

In downstream analysis, a framework-based analysis can be associated with prompts that support extracting information about how a threat actor might go about exploiting the vulnerability. The extract information can include the stage of the attack chain that they would engage with, the preconditions that are required to trigger the attack, the post-conditions (final state) that a successful attack would leave the system, as well as a myriad of risk and impact analysis scores.

Downstream analysis can further include one or more scored based analysis (e.g., an entity risk score analysis and email risk score analysis). For an entity risk score, a prompt for entity risk score analysis extracts a list of vulnerability entities or artifacts from the email where appropriate. Vulnerability entities can include URLs, IP addresses, host names, account names, file names, certificate thumbprints, etc. For email risk score, a prompt for email risk score analysis ideally should be the initial pre-processing step (i.e., a first data instance) and feeds into the remaining emails (i.e., the dataset) to help level-set the risk. Email risk score analysis provides a top-down risk analysis of each email, by assigning risk and other scores along various attributes/pivots. Passing this information into each of the above three previous prompts helps set the stage or initialize a prompt-based analysis context and calibrate the risk scores accordingly.

Downstream analysis can also include follow-up ranking prompt or “ranking prompt” that supports prioritizing or reordering data items based on their relevance or importance in subsequent stages or iterations downstream analysis. By way of illustration, after the above prompts are executed on the remaining output (i.e., remaining dataset), the data is aggregated, and a final prompt is executed to provide a risk ranking for the final output. This risk ranking includes various few shots or zero shots with calibrated scores. This risk ranking is used to calibrate and create a final set of triaged emails.

It is contemplated that the utilization of prompts such as relevance prompts (e.g., vulnerability prompts) and framework-based prompts (e.g., structured cybersecurity framework prompts), in conjunction with entity relevance scoring prompts (e.g., entity risk score analysis) and data item relevance scoring (e.g., email risk score analysis), as well as follow-up ranking prompts (e.g., ranking prompts) can extend beyond the realm of cybersecurity email risk assessment into various domains, including healthcare and legal discovery. In healthcare, for instance, relevance prompts could facilitate the identification of critical patient data essential for accurate medical diagnoses, ensuring that healthcare professionals prioritize pertinent information efficiently. Similarly, in legal discovery, the application of framework-based prompts may aid in organizing vast collections of legal documents according to relevant legal frameworks, streamlining the process of legal analysis and document review.

### Example Systems and Resources

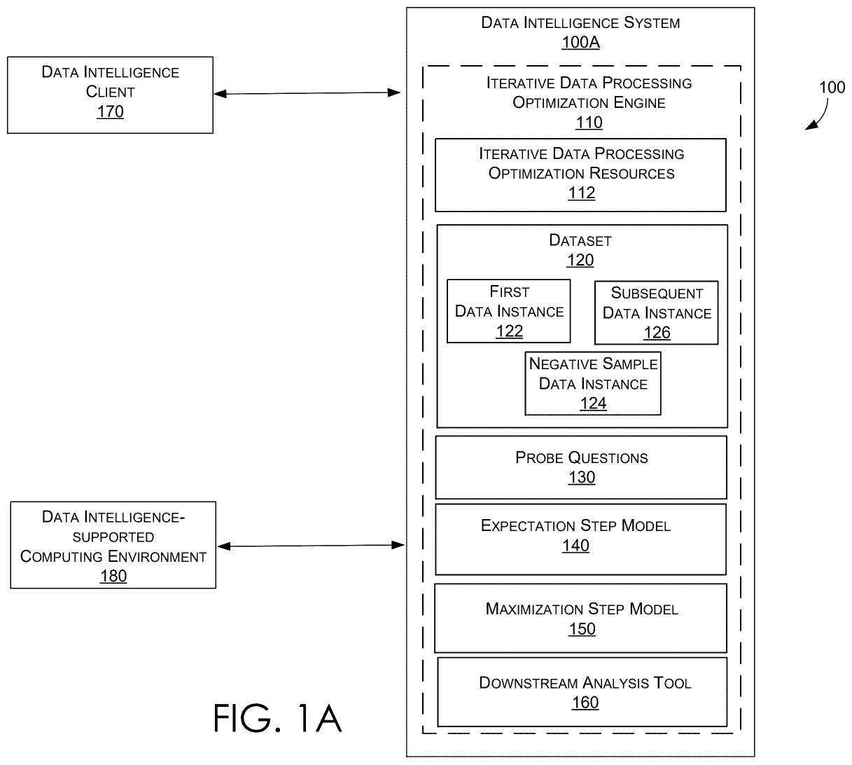

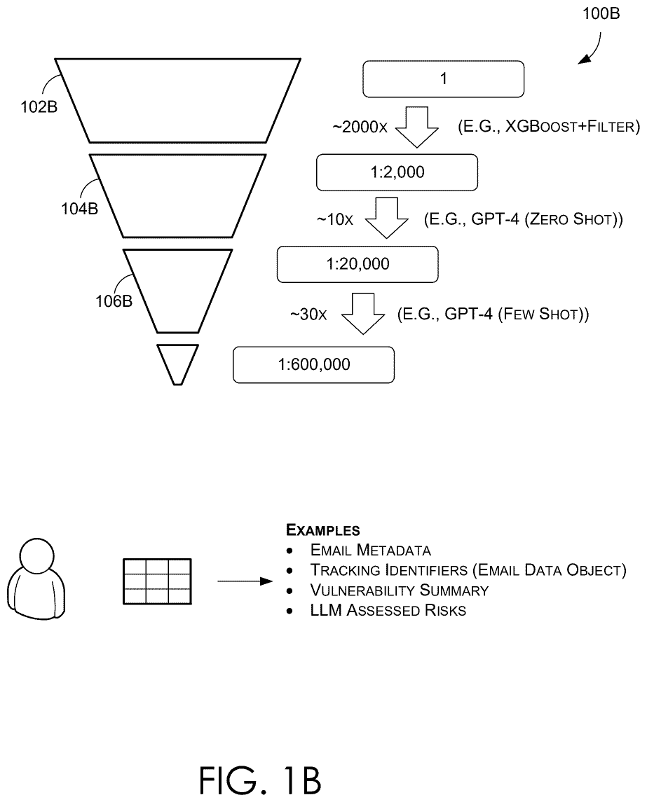

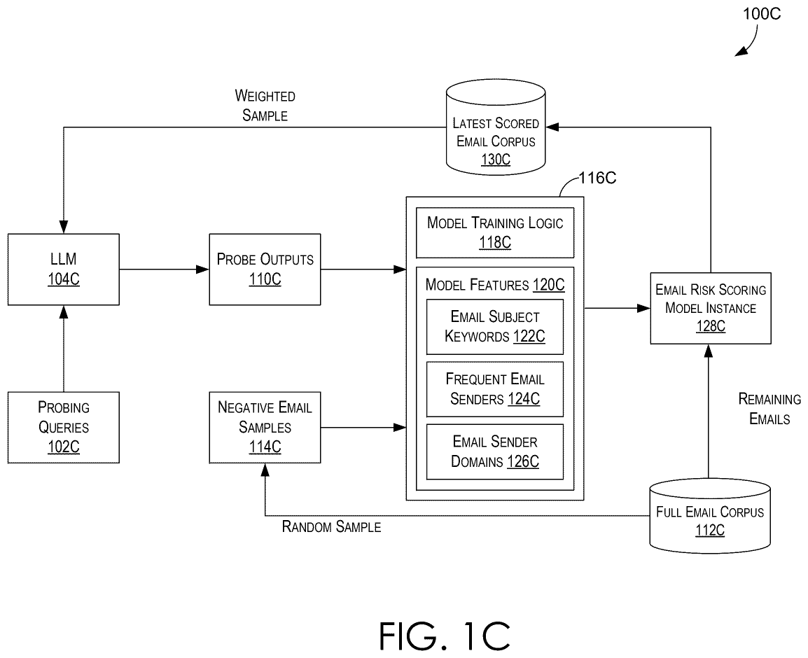

Aspects of the technical solution can be described by way of examples and with reference to FIGS. 1A-1C. FIG. 1A illustrates a cloud computing environment (system) 100, data intelligence system 100A, iterative data processing optimization engine 110, iterative data processing optimization resources 112, dataset 120 with data instance 122, negative sample data instance 124, subsequent data instance 126, probe questions 130, expectation step model 140, maximization step model 150; downstream analysis tool 160; data intelligence 170; an data intelligence-supported computing environment 180.

Cloud computing system 100 includes data intelligence system 100A that provides an operating environment for iterative data processing optimization engine 100 that operates with data intelligence client 170 and data intelligence-supported computing environment 180. The iterative data processing optimization engine 100 operates in conjunction with a data intelligence client 170, facilitating the provisioning of iterative data processing functionality that can be tailored data intelligence-supported computing environment 180. For example, through user interactions via the data intelligence client 170, the data intelligence client 170 leverages the iterative data processing optimization capabilities (e.g., Iterative data processing optimization resources 112) to iteratively train machine learning models and analyze datasets (e.g., dataset 120) associated with data intelligence-supported computing environment 180.

Iterative data processing optimization resources 112 include operations, interfaces, and data that support providing iterative data processing functionality. At its core, a series of essential operations orchestrate the transformation of raw data into actionable insights. The operations encompass, data ingestion, data preprocessing, model training, model deployment, and iterative training; the interfaces include graphical user interface controls, visualizations and command-line interfaces; and data includes different types of datasets, data instances, probe questions, observed expectation output data, maximization output data, and downstream analysis output data.

The iterative data processing optimization engine 110 provides a set of probe questions (e.g., probe questions 130) associated with a data instance (e.g., first data instance 122). The set of probe questions support evaluating the data instance of the dataset, the data instance is a selected cluster of data items identified based on keyword-based identifiers and one or more machine learning clustering techniques.

The data instance includes a plurality of data items. The expectation step model 140 generates an observed expectation output for the set of probe questions and data items in the data instance. The expectation step model 140 can be a large language model (LLM) that generates responses based on probe questions 130 for the observed expectation output. The observed expectation output is in an M×N matrix, where M is a number of initial filtered data items of the data instance, and N is a number of probe questions.

Training input data associated with the first data instance 122 is provided. The training input data is provided as a compressed representation of data items in the first data instance 122. The iterative data processing optimization engine 110 trains a maximization step model 150 on the observed expectation output and the training input data. The maximization step model 150 can be a predictive model. The maximization step model 150 is trained as an iteratively trained machine learning model based on a plurality of data instances of the dataset and one or more negative sample data instances. Training the maximization step model 150 can further be based on negative sample data instance 124, where the negative sample data instance 124 comprises data items that are automatically assigned a regression output of zero.

The maximization step model 150 generates a predicted output for data items in the dataset. The expectation step model 140 is associated with an expectation step and the maximization step model 150 is associated with a maximization step. The expectation step is executed to define a probing mechanism and the maximization step is executed to approximate the probing mechanism, the expectation step and the maximization steps are iteratively executed.

The iterative data processing optimization engine 110 identifies a subsequent data instance (e.g., subsequent data instance 126) from the dataset for a second iteration of iteratively training of the maximization step model 150. The subsequent data instance 126 is a new weighted sample of the dataset, the new weighted sample is weighted based on the predicted output. The iterative data processing optimization engine 110 triggers the second iteration of iteratively training the maximization step model based on the subsequent data instance 126. The second iteration of iteratively training the maximization step model is based on an updated set of probe questions, where the updated set of probe questions are refined based on the responses associated with the observed expectation output.

The downstream analysis tool 160 supports using a plurality of LLMs to generate downstream output based on executing one or more downstream prompts on the predicted output. Downstream output for a data item in a dataset refers to the final result or outcomes derived from processing that data item through various stages or prompts within an analytical pipeline. These prompts can include relevance prompts, framework-based prompts, and scoring prompts, each serving distinct purposes in extracting meaningful insights. A relevance prompt focuses on identifying structured and pertinent information within a data item. framework-based prompt operates within a known framework or structured approach to extract information. A scoring prompt involves evaluating one or more features of the data items against specified criteria or metrics. This can include numerical assessments, qualitative evaluations, or comparative rankings aimed at quantifying the quality, relevance, or performance of data elements. The outputs generated could range from structured data points, classifications, or scores that facilitate decision-making or further analysis.

Operationally, the one or more prompts are selected from the following: a relevance prompt associated with identifying structured relevant information; a framework-based prompt associated with extract information based on a known framework; and a scoring prompt associated with scoring one or more features of the data items. The downstream output is ranked and communicated to cause display of the downstream output. Ranking the downstream output is based on a follow-up ranking prompt that supports prioritizing or reordering data items based on downstream output associated with the plurality of LLMs.

With reference to FIG. 1B, FIG. 1B illustrates a data funneling framework associated with iterative data processing optimization engine. The data funneling framework can be a vulnerability funnel processing for identifying risk emails in an email data corpus. By way of context, an email corpus may represent a huge dataset that needs to be reduced in an efficient manner. A risk funnel pipeline, that includes expectation step models, maximization step models, and downstream analysis LLMs, can be used to efficiently reduce and analyze the dataset.

The funneling framework includes a first stage 102B that includes an optimized traditional ML (e.g., XGBoost) can be used for speed and performance, particularly for its scalability and accuracy in structured/tabular data prediction tasks; and filtering can include data processing for selecting or removing data points based on specific criteria, such as value thresholds, to refine datasets for analysis or modeling purposes. A second stage 104B that includes LLM-based zero-shot learning from new tasks or categories the LLM has not been explicitly trained on, often by leveraging semantic similarities between known and unknown categories.

A third stage 106B, few-shot learning that involves training a model on a minimal amount of labeled data, typically just a few examples per class, enabling it to generalize to unseen data more effectively than traditional approaches that require large datasets. The output from the funneling framework can be a subset of relevant data items of the dataset with corresponding contextual information. For example, a subset of email data items with email metadata, tracking identifies, vulnerability summary and LLM-generated assessed risk.

With reference to FIG. 1C, FIG. 1C depicts flow diagram 100C associated with the iterative data processing optimization engine. A predicted output can be generated via a trained maximization step model (e.g., email risk scoring model instance 124C) that is trained based on observed expectation output (e.g., probe outputs 110C) from an expectation step model (e.g., LLM 108C). The inputs into the maximization step model can include the observed expectation output (e.g., probe outputs 110C) and negative sample data instance (e.g., negative email samples 104C). The observed expectation output includes probe outputs (e.g., a latest probe output or a union of all probe outputs) and the negative sample data instance includes data items the model should ignore. The model features refer to predictors, independent variables, or input variables, are the attributes or characteristics of the data used by the model to make predictions or classifications (e.g., keywords from email subjects 118C, very frequent email senders 120C, email sender domains 122C).

As shown in FIG. 1C, probing queries 102C (e.g., probing questions that illicit a binary response) can provided to LLM 104C (i.e., expectation step model) to generate probe outputs 110C. The probe outputs 110C can be generated with a first data instance (not shown) from the full email corpus 112C. The probe outputs 110 may indicate a relevance of each sample of email with respect to the probing queries 102C. Full email corpus 112C may be accessed for retrieving a random sample of data items that are negative email samples 104C (i.e., negative sample data instance). The probe outputs 102C, negative email samples 114, training input data (e.g., embeddings of data items in the data instance) are provided to model engine 116C.

Model engine 116C includes model training logic 118C and model features 120C comprising email subject keywords 122C, frequent email senders 124C, and email sender domains 126C. The model training logic 118C is utilized for training the email risk scoring model instance 128C that is used in generating predicted output (i.e., latest score email scored email corpus 130C) associated with remaining emails in the full email corpus 112C. As part of the iterative data processing, the latest score email scored email corpus 130C is used to generate a new weighted sample.

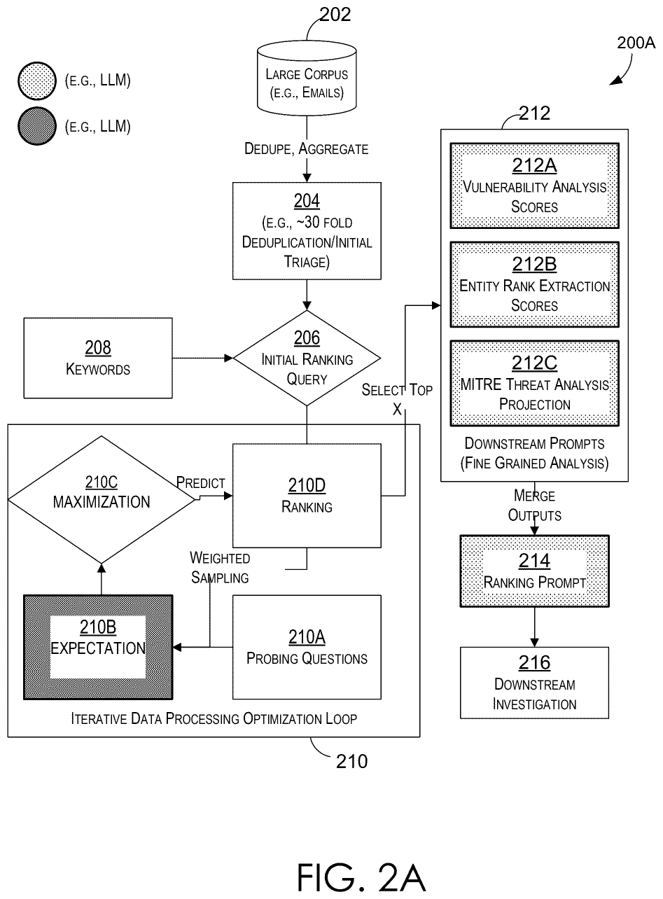

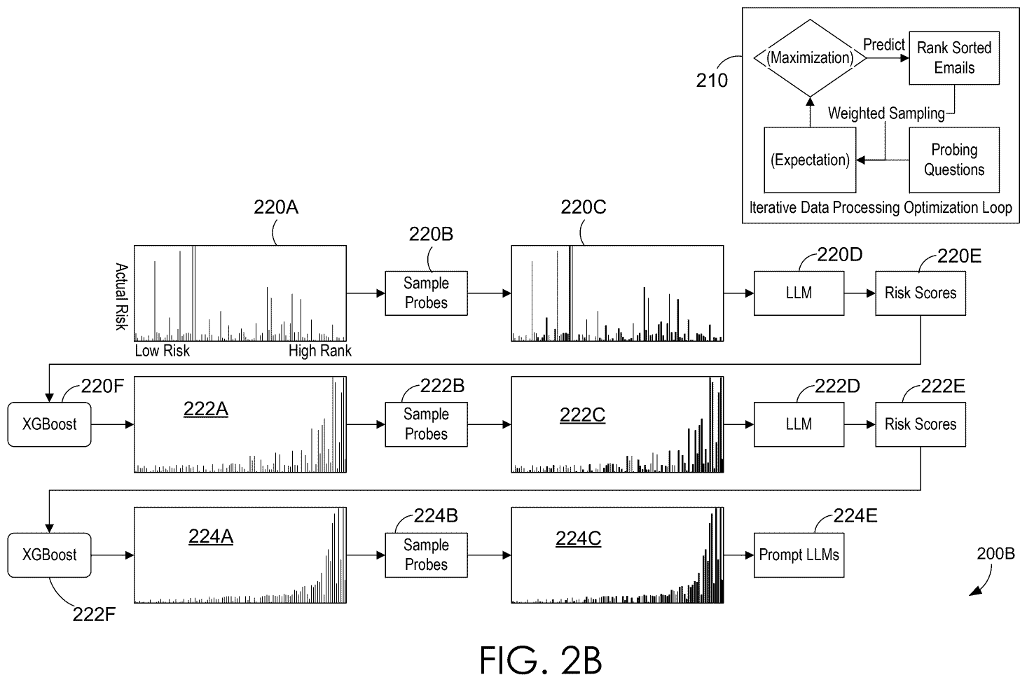

With reference to FIG. 2A, FIG. 2 illustrates a flow diagram 200A associated with a cybersecurity example implementation of the technical solution described herein. The cybersecurity example is associated with evaluating risk associated with emails in an email corpus-large corpus 202. Initial triage 204 may include a de-duplication of data items in a first data instance. The de-duplication may include one or more of an exact matching technique, a fuzzy matching technique, keyword-based de-duplication, a rule based de-duplication, machine learning based de-duplication (e.g., a supervised learning model logistic regression or neural network), a cluster-based deduplication, etc. Additionally or alternatively, the initial triage 304 may include aggregating some of the data items (e.g., groupings based on keywords).

Initial ranking query 206 may include applying a keyword-based identification of the data items of the first data instance using keywords 208. To illustrate, the keyword identification may be applied to one or more clusters of the data items, the clusters generated using one or more machine learning clustering techniques (e.g., k-means clustering, hierarchical clustering, density-based spatial clustering of applications with noise, mean shift clustering, Gaussian mixture models, agglomerative clustering, affinity propagation, etc.). In some embodiments, a portion of data items from the large corpus 202 include emails, and the emails are curated by applying a combination of keyword-based identifiers from keywords 208 to clusters of the emails derived using machine learning clustering techniques on the email subjects. In some embodiments, a portion of data items from the large corpus 202 include documents, and the documents are curated by applying a combination of keyword-based identifiers from keywords 208 to clusters of the documents derived using machine learning clustering techniques on the document subjects.

The first data instance is then provided to the iterative data processing optimization loop 210 that implements the LLM-based Expectation Maximization (EM) technical solution. The iterative data processing optimization loop 210 begins with probing questions 210A and iterates through steps 210B-210D of the iterative data processing optimization loop 210.

The set of probing questions 110A are provided to expectation step 210B, and the expectation step 210B may have a wrapper prompt (e.g., yes/no) that is queued up to be executed on the set of data items from the data instance. The expectation step 210B then generates an observed expectation output.

The observed expectation output from the expectation step 210B is provided to the maximization step 210C associated with a maximization step model, such as a LightGBM or XGBoost, for fitting. The maximization steps can include using the trained model to generate the predicted output based on remaining emails in the large corpus 202. The predicted output from the maximization loop 210C can be ranked at a ranking step 210D to rank the predicted output. The ranked predicted output can be used to generate a new weighted sample of emails (i.e., a subsequent data instance) that is used for a second iterative data processing optimization loop.

In addition, or alternatively, the predicted output can be generated such that a subset of the ranked predicted output is processed using downstream prompts associated with LLMs. The prompts can be associated generating vulnerability analysis scores 212A, entity rank extraction scores 212B, and MITRE ATT&CK® threat analysis projection score 212C. After executing the downstream prompts 212, ranking prompt 214 can be executed of merged outputs from downstream prompts 212. The ranking prompt 314 may apply a final prompt to generate a risk ranking against this final output. The ranking prompt 314 may include one or more few shots or zero shots with calibrated scores, which may be used to calibrate and create a final set of triaged emails to provide to the downstream investigation 216.

With reference to 2B, FIG. 2B is a schematic illustrating iterative data processing optimization. A dataset 220A can include a plurality of data items that can have different measures of relevance for a particular topic. For example, emails have different risk scores. The dataset 220A can be processed using an iterative data processing optimization loop from 220A to 224D for downstream analysis using prompt LLMs 224E.

As shown, dataset 220A can be evaluated using sample probes 220B for a data instance 220C associated with a subset of the dataset 220A. The sample probes 220B and data instance 220C are processed via LLM 220D to generate risk scores 220E as first observed expectation output. The risk scores 220E and training input data are used to train XGBoost 220F, where the XGBoost 220F is used to score and rank dataset 220A to dataset 222A.

A second iteration of the iterative data processing optimization loop 210 is performed for dataset 22A, sample probes 22B, subsequent data instance 22C, that are processed via LLM 222D to generate risk scores 222E as a second observed expectation output. The risk scores 222E and training data input are used to train XGBoost 222F, where the XGBoost 222F is used to score and rank dataset 222A to dataset 224A. Another iteration can be associated with sample probes 224B and data instance 224C, where the data instance 224C undergoes downstream analysis via prompt LLMs 224E.

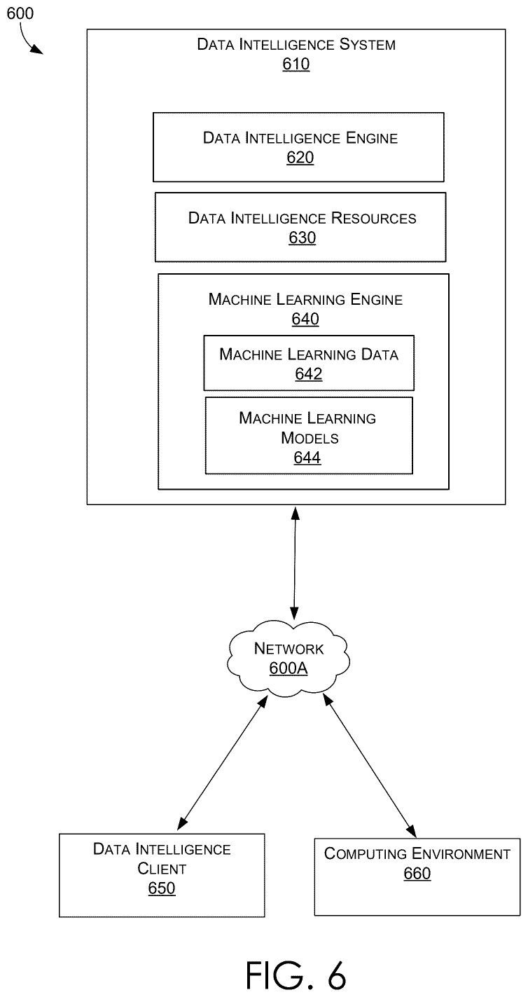

Aspects of the technical solution have been described by way of examples and with reference to FIGS. 1A, 1B, 1C, 2A and 2B. FIG. 1A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1A illustrates a high level architecture of the cloud computing system 100 in accordance with implementations of the present disclosure, among other engines, managers, generators, selectors, or components not shown (collectively referred to herein as “components”).

### Example Methods

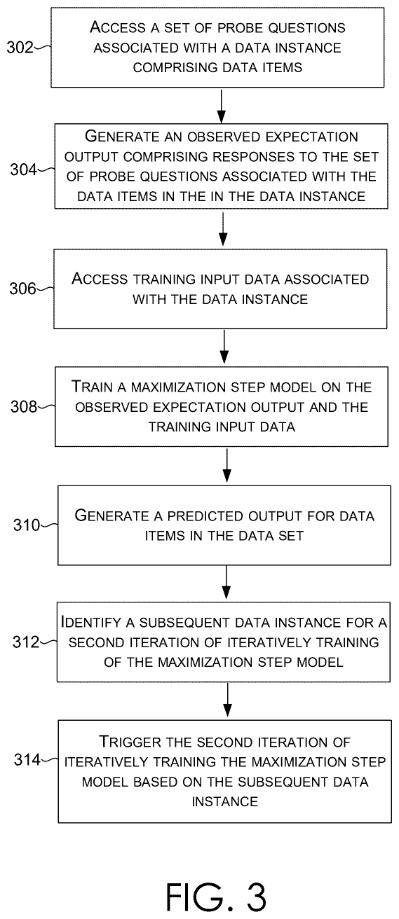

With reference to FIGS. 3, 4, and 5, flow diagrams are provided illustrating methods for providing iterative data processing optimization using an iterative data processing optimization engine in a data intelligence system. The methods may be performed using the design system described herein. In embodiments, one or more computer-storage media having computer-executable or computer-useable instructions embodied thereon that, when executed, by one or more processors can cause the one or more processors to perform the methods (e.g., computer-implemented method) in the data intelligence system (e.g., a computerized system).

Turning to FIG. 3, a flow diagram is provided that illustrates a method 300 for providing iterative data processing optimization using an iterative data processing optimization engine in a data intelligence system. At block 302, access a set of probe questions associated with a data instance comprising data items. The data instance is a subset of a dataset. At block 304, generated an observed expectation output comprising responses to the set of probe questions associated with the data items in the data instance. The expectation step model is a large language model (LLM) that generates the responses in the observed expectation output using the set of probe questions and the data instance. At block 306, access training input data associated with the data instance. At block 308, train a maximization step model on the observed expectation output and the training input data. The maximization step model is a predictive model. At block 310, use the maximization step model to generate a predicted output for data items in the data instance. At block 312, identify a subsequent data instance from the dataset for a second iteration of iteratively training the maximization step model. At block 314, trigger the second iteration of iteratively training the maximization step model based on the subsequent data instance.

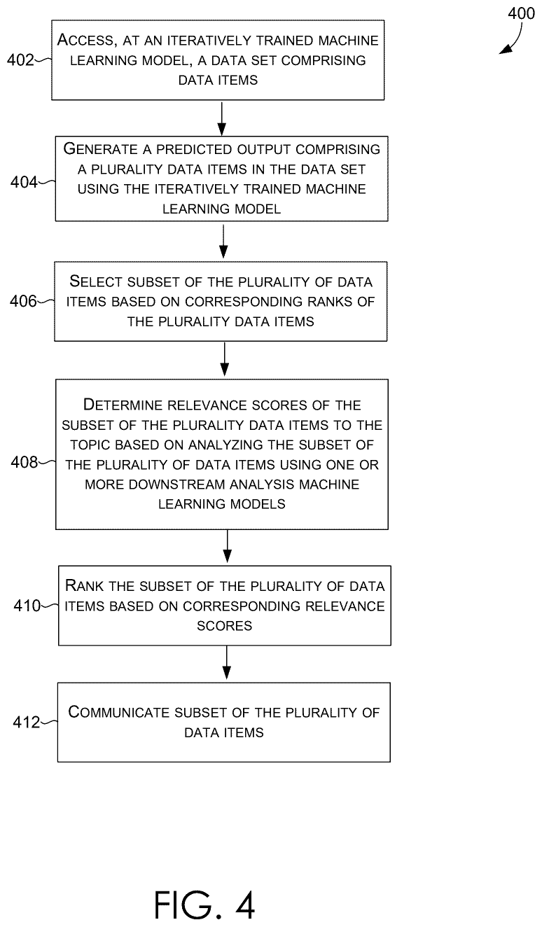

Turning to FIG. 4, a flow diagram is provided that illustrates a method 400 for providing iterative data processing optimization using an iterative data processing optimization engine in a data intelligence system. At block 402, access, at an iteratively trained machine learning model, a dataset comprising data items. The iteratively trained machine learning model is trained based on two or more iterations of observed expectation outputs associated with a set of probe questions associated with a topic. At block 404, use the iteratively trained machine learning model to generate predicted output comprising a plurality of data items in the dataset. At block 406, select a subset of the plurality of data items based on the corresponding ranks of the plurality of data items. At block 408, use a plurality of LLM's to generate a downstream output based on executing one or more downstream prompts on the predicted output. At block 410, rank the downstream output. At block 412, communicate the downstream output to cause display of the downstream output.

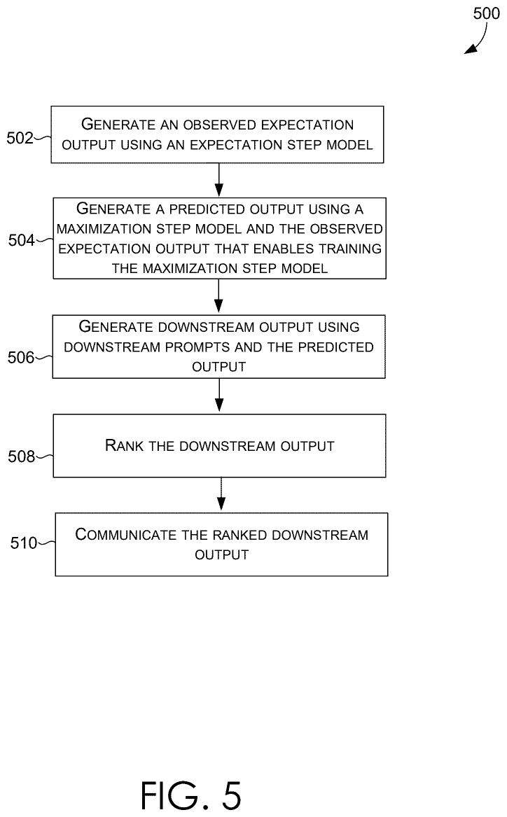

Turning to FIG. 5, a flow diagram is provided that illustrates a method 500 for providing iterative data processing optimization using an iterative data processing optimization engine in a data intelligence system. At block 502, generate an observed expectation output using an expectation step model. At block 504, generate a predicted output using a maximization step model and the observed expectation output that enables training the maximization step model. At block 506, generate downstream output using downstream prompts and the predicted output. At block 508, rank the downstream output. At block 510, communicate the ranked downstream output.

### Technical Improvement

Embodiments of the present techniques have been described with reference to several inventive features (e.g., operations, systems, engines, and components) associated with a design system. Inventive features described include: operations, interfaces, data structures, and arrangements of computing resources associated with providing the functionality described herein relative with reference to an iterative data processing optimization engine. Functionality of the embodiments of the present invention have further been described, by way of an implementation and anecdotal examples—to demonstrate that the operations for providing the iterative data processing engine as a solution to a specific problem in data intelligence technology to improve computing operations in data intelligence systems.

Advantageously, iterative data processing optimizing processes involves leveraging various forms and perspectives of data at different stages. This approach implements a framework that acknowledges that different types of views or modalities may be most efficiently processed and analyzed using distinct tools or methods tailored to their characteristics. Moreover, considering diverse views of data-whether summarizing trends or delving into granular details-allows for nuanced insights and informed decision-making. By strategically employing these different views throughout a workflow, organizations can streamline operations, enhance analytical depth, and ultimately achieve higher efficiency and effectiveness in their data intelligence operations.

In this way, the iterative data processing optimization engine employs expectation step machine learning models that are simple but with fast large language models (LLMs) to efficiently probe and analyze data (e.g., probing mechanism). The iterative data processing optimization engine also iteratively refines maximization step machine learning models that are optimized and fast to approximate the probing mechanism of the expectation step machine learning models more efficiently, for example, using metadata, external information or compressed representation (e.g., embeddings). The iterative data processing optimization engine can operate based on an agentic framework using lightweight artificial intelligence (AI) agents to perform model fitting, featurization, and report generation autonomously. In this way, iterative data processing optimization engine enables processing large datasets to identify action insights via an automated data processing pipeline that ensures efficient and precise analysis.

### Additional Support for Detailed Description

### Example Data Intelligence System in a Cloud Computing Environment

Referring now to FIG. 6, FIG. 6 illustrates a computing environment in which implementations of the present disclosure may be employed. In particular, FIG. 6 shows a high level architecture of an example cloud computing platform 600 and data intelligence system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing environment 100 provides computing system resources for different types of managed computing environments. For example, the cloud computing platform supports delivery of computing services-including compute, servers, storage, databases, networking, and intelligence. The components of cloud computing environment 600 may communicate with each other over a network 600A which may include, without limitation, one or more local area networks (LANs) and/or wide area networks (WANs).

The data intelligence system 610 provides data intelligence functionality for computing environments. The data intelligence system 610 is a platform or framework that leverages advanced technologies such as artificial intelligence (AI), machine learning (ML), data mining, and big data analytics to extract actionable insights and knowledge from large and complex datasets. In this way, the data intelligence system 610 provides a computing environment that enables organizations to make informed decisions and optimize operations.

The data intelligence system 610 can be implemented as a security management system that supports planning, implementing, controlling, and monitoring security measures to protect assets, resources, and information from various threats and risks in computing environment. Data intelligence system 610 as a security management system is configured to trigger alerts for potential or actual threats-including suspicious behavior or malicious behavior—in a computing environment. For example, an alert configuration can be defined to include alert settings, which if met, trigger an alert. The security alert can refer to a human-readable, technical notification regarding current vulnerabilities, exploits, and other security issues associated with a computing environment. The alert can be communicated to a client device that is managed by a security administrator who can then follow up on the alert. The security management system can be a security management system described in U.S. patent application Ser. No. 18/451,405, filed Aug. 17, 2023, entitled “ARTIFICIAL INTELLIGENCE ENGINE IN A SECURITY MANAGEMENT SYSTEM,” which is incorporated herein by reference in its entirety.

The data intelligence system 610 can further support generating security posture visualizations based on security management engine output. The security posture information can be generated security management engine output such that security posture information is prioritized and filtered. A prioritization identifier (e.g., high, medium, low) can be provided in the security posture visualization in combination with an alert associated with a security incident. Alternatively, a notification associated with the security management information, security prioritization information or the alert can be communicated. Other variations and combinations of communications associated with security management engine output are contemplated with embodiments described herein.

The data intelligence system 610 includes a data intelligence engine 620 that is a computing environment that supports executing computational tasks associated with the data intelligence system 610. The data intelligence engine 620 can be a hardware or software component that performs computational operations, such as, mathematical calculations, data processing, and algorithm execution. The data intelligence system 610 integrates data intelligence resources 630 into data intelligence system 610 to effectively provide data intelligence functionality in a computing environment.

The data intelligence engine 620 may collect, aggregate, and integrate data from diverse sources, including structured and unstructured data, internal and external data sources, streaming data, and historical data repositories. The data intelligence engine 620 may further applying a variety of analytical techniques and algorithms, they automate the process of extracting insights, employing machine learning algorithms, AI techniques, and predictive analytics to discover patterns, classify data, make predictions, and generate recommendations.

The data intelligence engine 620 provides visualization tools and dashboards to enable users to explore data, identify trends, and communicate insights effectively, while robust data governance policies and security measures ensure that data is managed and accessed securely, compliantly, and ethically. The data intelligence system 610 is designed for scalability and performance, in this way the data intelligence system 610 can handle large volumes of data and support high-performance analytics, including real-time and streaming analytics capabilities for faster decision-making and proactive interventions.

The data intelligence resources 630 refer to computing elements (e.g., components, capability, or entities) that collectively enable the data intelligence engine 620 operations. The data intelligence resources 630 encompass a spectrum of computing elements, beginning with the diverse operations the data intelligence resources 630 can perform, ranging from complex computations to data manipulations. Interfaces, an integral part of the data intelligence resources 630, provide the means for both user interaction and seamless integration with external systems, ensuring a dynamic and interactive computing experience. The data facet of the data intelligence resources 630 involves various types: input data, which is the information provided for processing; processing data, representing the data manipulated during computational tasks; and output data, the results generated by the data intelligence engine 620. In this way, the data intelligence resources 630 support the broader data intelligence engine 620 and data intelligence system 610.

Data intelligence resources 630 include operations, interfaces, and data that support providing data intelligence functionality-operations encompass the tasks performed on the data, interfaces facilitate interaction with the data intelligence system 610, and data serves as the input and output of the system's operations, forming the core components of a data intelligence system. In particular, iterations in a data intelligence system 610 encompass tasks such as data acquisition, preprocessing, analysis, model training, inference, visualization, and reporting. Operations involve manipulating data to extract insights and intelligence. For instance, preprocessing may involve cleaning and transforming data, while analysis could include descriptive statistics or predictive modeling. Interfaces serve as points of interaction between users, applications, and the system, facilitating access to functionality and consumption of outputs. Examples include graphical user interfaces (GUIs), command-line interfaces (CLIs), and application programming interfaces (APIs), and data visualization tools, which allow users to interact with and visualize results. Data, comprising raw and processed information, serves as the input and output of system operations. Data may originate from various sources, structured or unstructured, and undergo preprocessing before analysis. Examples include customer data, financial data, and sensor data stored in formats like databases or data lakes.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The data intelligence client 650 supports access to data intelligence system 610 660. The data intelligence client 650 can be provided as a user client or an administrator client to support user and administrator functionality associated with the computing environment 660, data intelligence engine 620, or data intelligence system 610. The data intelligence client 650 can also support accessing data intelligence visualizations and causing display of the data intelligence visualization. The data intelligence client 650 can include a data intelligence engine client that supports receiving data intelligence information associated data intelligence engine 620 output from the data intelligence system 610 and causing presentation of the data intelligence information. The data intelligence information can specifically include data intelligence visualizations associated with the data intelligence engine 620 output.

Data intelligence client 650 provides a graphical or command-line interface for users or administrators to interact with data intelligence system 610. The data intelligence client 650 serves as the interface between users or systems and the underlying data intelligence system, facilitating interactions, querying data, retrieving results, and visualizing insights derived from analyzed data. Users can configure and customize system behavior, adjust parameters, and define workflows through the client interface, tailoring the system to specific use cases or requirements. Interactive visualization tools, including charts, graphs, maps, and dashboards, enable users to explore and interpret data intuitively. Some clients offer built-in tools for data analysis, statistical modeling, and machine learning, allowing users to uncover patterns and trends within the data. Collaboration features support sharing insights, collaborating on analyses, and communicating findings with colleagues or stakeholders. Security measures such as user authentication, access control, encryption, and audit logging ensure data protection and compliance with security policies and regulations.

The data intelligence client 650 can further support executing a remediation action. In particular, the security posture visualization can include a remediation action for an alert associated with data intelligence engine 620 output. The data intelligence client 650 can receive an indication to perform the remediation action associated with data intelligence engine 620 output. Based on receiving the indication to execute the remediation action, the data intelligence client 650 can communicate the indication to execute the remediation action to cause execution of the remediation action.

Computing environment 660 is a computing environment that is integrated into the data intelligence system 610. The computing environment 660 is characterized by an infrastructure, where data from various sources within the ecosystem, including servers, networks, applications, sensors, and user interactions, can be aggregated and processed by the data intelligence system 610 to derive actionable insights. The computing environment 660 can be associated with middleware and integration layers facilitate seamless data flow, while computing infrastructure, encompassing cloud-based resources, distributed computing frameworks, and optimized storage systems, supports functionality associated with the data intelligence.

### Example Distributed Computing System Environment

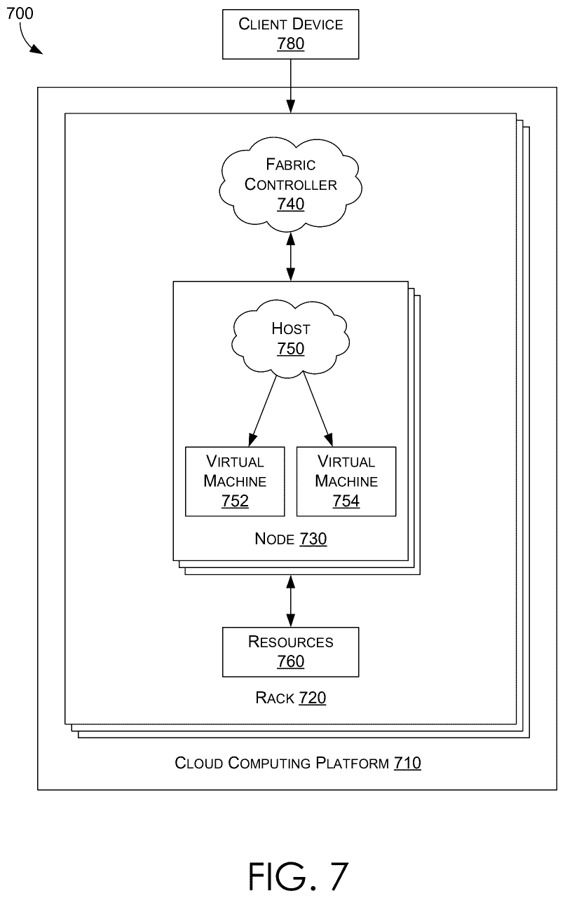

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

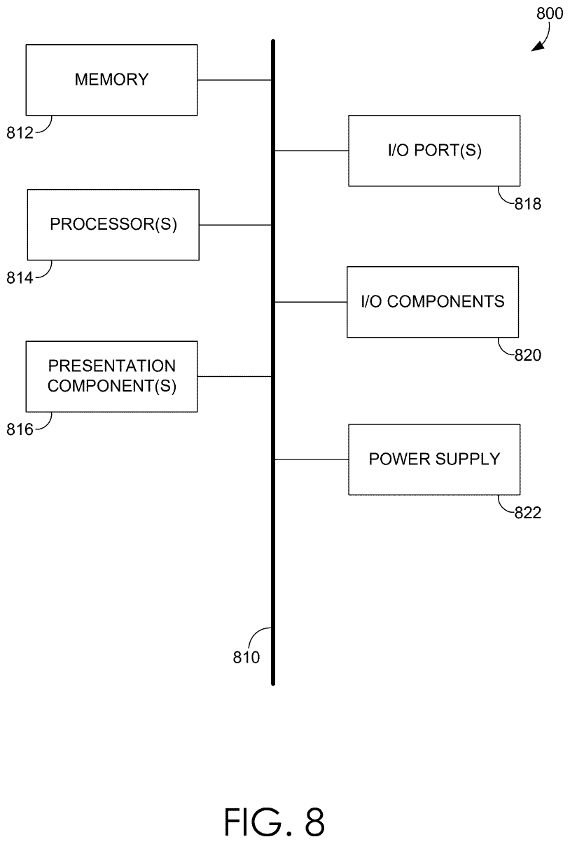

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a set of probe questions associated with a data instance comprising data items, wherein the data instance is a subset of a dataset;
using an expectation step model, the set of probe questions, and the data instance, generating an observed expectation output comprising responses to the set of probe questions associated with the data items in the data instance, wherein the expectation step model is a large language model (LLM) that generates the responses in the observed expectation output using the set of probe questions and the data instance;
accessing training input data associated with the data instance;
training a maximization step model on the observed expectation output and the training input data, wherein the maximization step model is a predictive model;
using the maximization step model, generating a predicted output for the data items in the data instance;
identifying a subsequent data instance from the dataset for a second iteration of iteratively training of the maximization step model; and
triggering the second iteration of iteratively training the maximization step model based on the subsequent data instance, wherein iteratively training the maximization step model comprises iteratively fitting in the maximization step model based on iterations of observed expectation outputs associated with iterations of data instances of the dataset.

2. The system of claim 1, wherein the expectation step model is associated with an expectation step and the maximization step model is associated with a maximization step, wherein the expectation step is executed to define a probing mechanism and the maximization step is executed to approximate the probing mechanism, the expectation step and the maximization steps are iteratively executed.

3. The system of claim 1, wherein the observed expectation output is in an M×N matrix, wherein M is a number of initial filtered data items of the data instance, and N is a number of probe questions.

4. The system of claim 1, training the maximization step model is further based on a negative sample data instance, wherein the negative sample data instance comprises data items that are automatically assigned a regression output of zero.

5. The system of claim 1, wherein the subsequent data instance is a new weighted sample of the dataset, the new weighted sample is weighted based on the predicted output.

6. The system of claim 1, the second iteration of iteratively training the maximization step model is based on an updated set of probe questions, wherein the updated set of probe questions are refined based on the responses associated with the observed expectation output.

7. The system of claim 1, the operations further comprising:
using a plurality of LLMs, generating a downstream output based on executing one or more downstream prompts on the predicted output;
ranking the downstream output; and
communicating the downstream output to cause display of the downstream output.

8. A method, the method comprising:
accessing a set of probe questions associated with a data instance comprising data items, wherein the data instance is a subset of a dataset;
using an expectation step model, generating an observed expectation output for the set of probe questions and the data items in the data instance and, wherein the expectation step model is a large language model (LLM) that generates responses to the set of probe questions for the observed expectation output;
training a maximization step model on the observed expectation output and the training input data associated with the data instance, wherein the maximization step model is a predictive model;
using the maximization step model, generating a predicted output for data items in the data instance.

9. The method of claim 8, wherein the set of probe questions support evaluating the data instance of the dataset, the data instance is a selected cluster of data items identified based on keyword-based identifiers and one or more machine learning clustering techniques.

10. The method of claim 8, wherein the expectation step model is associated with an expectation step and the maximization step model is associated with a maximization step, wherein the expectation step is executed to define a probing mechanism and the maximization step is executed to approximate the probing mechanism, the expectation step and the maximization steps are iteratively executed.

11. The method of claim 8, wherein the training input data is provided as a compressed representation of data items in the data instance.

12. The method of claim 8, the method further comprises:
identifying a subsequent data instance from the dataset for a second iteration of iteratively training of the maximization step model; and
triggering the second iteration of iteratively training the maximization step model based on the subsequent data instance.

13. The method of claim 8, the method further comprising:
using a plurality of LLMs, generating a downstream output based on executing one or more downstream prompts on the predicted output;
ranking the downstream output; and
communicating the downstream output to cause display of the downstream output.

14. The method of claim 8, wherein the one or more downstream prompts are selected from the following:
a relevance prompt associated with identifying structured relevant information;
a framework-based prompt associated with extract information based on a known framework; and
a scoring prompt associated with scoring one or more features of the data items.

15. One or more computer-storage media having computer-executable instructions embodied thereon that, when executed by a computing system having a processor and memory, cause the processor to perform operations, the operations comprising:
accessing, at an iteratively trained machine learning model, a dataset comprising data items, wherein the iteratively trained machine learning model is trained based on two or more iterations of observed expectation outputs associated with a set of probe questions associated with a topic;
using the iteratively trained machine learning model, generating predicted output comprising a plurality data items in the dataset;
selecting a subset of the plurality of data items based on corresponding ranks of the plurality data items;
using a plurality of Language Models, generating a downstream output based on executing one or more downstream prompts on the predicted output;
ranking the downstream output; and
communicating the downstream output to cause display of the downstream output.

16. The media of claim 15, wherein the iteratively trained machine learning model is associated with an expectation step model of an expectation step and a maximization step model of a maximization step,
wherein the expectation step is a first level associated with a first view or first modality of the dataset and a first computational cost, and
wherein the maximization step is a second level associated with a second view or second modality of the dataset and a second computational cost.

17. The media of claim 15, wherein the iteratively trained machine learning model is a maximization step model associated with an expectation step model, wherein the expectation step model is associated with an expectation step and the maximization step model is associated with a maximization step, wherein the expectation step is executed to define a probing mechanism and the maximization step is executed to approximate the probing mechanism, the expectation step and the maximization steps are iteratively executed.

18. The media of claim 15, wherein the set of probe questions support evaluating the data instance of the dataset, the data instance is a selected cluster of data items identified based on keyword-based identifiers and one or more machine learning clustering techniques.

19. The media of claim 15, wherein the iteratively trained machine learning model is iteratively trained based on a plurality of data instances of the dataset and one or more negative sample data instances.

20. The media of claim 15, wherein ranking the downstream output is based on a follow-up ranking prompt that supports prioritizing or reordering data items based on the downstream output associated with the plurality of LLMs.
